(19) United States
(12) Patent Application Publication
(10) Pub. No.: US 2019/0254260 A1
(43) Pub. Date: Aug. 22, 2019

(54) SYSTEM FOR OPERATING A SWINGING CHICKEN COOP DOOR

(71) Applicant: Hung Nguyen, Tallahassee, FL (US)

(72) Inventor: Hung Nguyen, Tallahassee, FL (US)

(21) Appl. No.: 15/900,855

(22) Filed: Feb. 21, 2018

(51) Int. Cl. A01K 31/02; A01K 31/18; G08C 17/02; G08B 21/18; G07C 9/00

(52) U.S. Cl. CPC A01K 31/02; A01K 31/18; G08B 27/005; G08B 21/18; G07C 9/00126; G08C 17/02

(57) ABSTRACT

Embodiments described herein provide for a chicken coop system having a housing defining an opening and a door movably engaged with the housing to suitably close and open the opening. A linear actuator is arranged to open and close the door after receiving manual or automated input from a controller.

### FIELD

The present invention generally relates to a system and method for an automated door for a chicken coop and method of use thereof.

### BACKGROUND

Chickens are commonly raised by individuals or as part of community collectives to alleviate concerns of unethical farming practices, unknown chemicals, among other health concerns. These chickens, whom are allowed to roam around outside during the daylight hours are known as free range chickens. It is believed that these chickens are healthier and produce more nutritious meat and eggs.

In many cases, these chickens are raised in rural environments where the risk of being attacked by nocturnal predators such as wolves, coyotes, fox and raccoons are high. To mitigate this factor, chickens are provided a coop which is shut near dusk and reopened at dawn. This task requires human intervention causing an inconvenience to the chicken rancher. While solutions exist to aid in these inconveniences, a more suitable solution is desired.

G.B. Patent No. 2,433,962 to Nicholas Sanderson Young discloses an automated door opening and closing system comprising a door, linkage arm motor and controller. The door is opening and closed by the motor raising and lowering the linkage arm. The controller dictates the switching of the motor, to open or close the door. The controller is comprised of either a solar (light level) sensor or a dusk/dawn timer. These may be used in conjunction with the delay on, delay off and a time clock timer(s).

G.B. Patent No. 2,546,728 to Simon John Dean discloses an actuator for opening and closing a hen house door, having a rotatable threaded shaft, a motor to rotate the shaft a running nut which moves along the shaft as the shaft rotates, and with a first end connected via a hinge to the running nut and a second end connected via a hinge to a foot for securement to a chicken coop door. There are means to secure the baseplate of the shaft mechanism to a position adjacent the door. There is a spring-loaded stop, to limit the travel of the running nut on the shaft. Preferably the actuator has a control device to control the motor at predetermined times. The control device includes a light sensor to open and close the door depending on sunlight levels. The light sensor may be set to a threshold level, and the sensor may measure current delivered to the motor. The control device has a memory to remember if the door was in a closed or open position in the event of a power failure. There may be an external light with a switch.

U.S. Pat. No. 8,020,519 to Thomas Perry Stamper discloses a chicken coop door module having a frame, a door, and a motor drive unit. The motor drive unit is configured to move the door toward the open position in response to receiving an opening signal so that the frame opening is unobstructed, move the door toward the closed position in response to receiving a closing signal so that the frame opening is obstructed, and prevent the door from moving when no signal is received. The door module receives an opening signal in the morning to let the chickens out of the coop, and a closing signal in the evening to close the door to secure the chickens in the coop. When no signal is received, the door is prevented from moving by the motor drive unit so that when open, the chickens may freely enter and exit the coop; and when close, predators cannot open the door and attach the chickens. The chicken coop door module may include a controller to provide the opening signal and the closing signal base on a signal from a timer or light detector.

U.S. Pat. No. 9,775,329 to Elam Miller discloses an automatic drive unit for a door assembly of the type having a frame with an opening, a door positionable within the opening between an open position and a closed position, and a door actuator for moving the door between the open and closed positions, includes a controller circuit having a power source, a timing circuit for reporting the date and a time to a processor, a non-volatile memory, a programmed set of instructions, and a display. The programmed set of instructions are adapted for receiving input of a location and open and close offset times and storing such information in the memory. The controller circuit executing the instructions determines based on its location and the date a sunrise time and a sunset time, opens the door at the sunrise time plus the open offset time, and closes the door at the sunset time plus the close offset time.

CN Patent No. 104,920,245 to Luo Tingting, et al. and assigned to Liuzhou Pigeon Breeding Company discloses a door of a pigeon cage. The door comprises a door opening, transverse rods, a first vertical rod, a second vertical rod, an electromagnetic structure, an iron block and a door plate, wherein the door opening is enclosed by the upper transverse rod, the lower transverse rod, the first vertical rod and the second vertical rod, the door plate is located in the door opening, two sides of one end of the door plate are respectively provided with the hinges, the other end of the door plate is provided with the electromagnetic structure, two accommodating cylinders are disposed on the first vertical rod and located on the upper and lower sides of the door plate respectively, the two accommodating cylinders are respectively matched with the two hinges, the iron block is disposed on the second vertical rod, the iron block is in magnetic connection with the electromagnetic structure, the electromagnetic structure comprises a power supply, an iron core and a coil, the coil winds the iron core and is connected with the power supply, one end of the iron core is welded to the door plate, and the other end of the iron core extends to the position of the iron block. The door of the pigeon cage has the advantages that the door is reasonable and simple in structure, the door plate cannot be damaged easily, magnetic connection is utilized, tightness and efficiency are achieved, and the door is applicable to large pigeon cages of centralized cultivation.

It can be seen that improvements in the arts of chicken ranching is warranted. Embodiments of one such solution are provided herein.

### SUMMARY OF THE INVENTION

Embodiments described herein provide for an automated chicken coop comprising a housing having an opening, wherein the opening is defined by a top frame portion, a bottom frame portion, a first side portion, and a second side portion. A pivot hinge is movably coupled to the first side portion while a door is movably coupled to the frame by the pivot hinge. The door has an edge dimensioned to be received by the opening. The door is movable between an open position wherein the door is substantially vertical and substantially perpendicular to the housing. The door may transition to a closed position wherein the door is substantially vertical and substantially parallel to the housing such that the opening is sufficiently obstructed by the door. A linear actuator has a fixed end and a work end. The fixed end is coupled to the pivot hinge while the work end is engaged with the door edge. The linear actuator is in communication with a motor configured to affect the linear actuator to forcefully rotate the door about a rotational axis provided by the pivot hinge between the open position and close positions. A controller is in communication with the motor while an interface provides an open signal and a close signal to the motor and thereby move the door to the open position and close positions.

In an embodiment, the system may include a photocell, a climate sensor, and a timer. Each is configured to determine an open time and a close time during which open signals and close signals are output.

In an embodiment, a memory stored relevant information such as open and close times.

The controller may be in communication with any number of users permitting the user to modulate the control from a remote location.

A door close switch may be arranged to be activated when the door is in the closed position. The door switch may have an alarm in communication thereto configured to provide an indication of when the alarm is activated. The controller alerts a remote user when the alarm is activated.

According to another embodiment of the present invention, a chicken coop system has a housing having an opening, wherein the opening is defined by a top frame portion, a bottom frame portion, a first side portion, and a second side portion. A pivot hinge is movably coupled to the first side portion while a door is movably coupled to the frame by the pivot hinge. The door has an edge dimensioned to be received by the opening. The door is movable between an open position wherein the door is substantially vertical and substantially perpendicular to the housing. The door may transition to a closed position wherein the door is substantially vertical and substantially parallel to the housing such that the opening is sufficiently obstructed by the door. A linear actuator has a fixed end and a work end. The fixed end is coupled to the pivot hinge while the work end is engaged with the door edge. The linear actuator is in communication with a motor configured to affect the linear actuator to forcefully rotate the door about a rotational axis provided by the pivot hinge between the open position and close positions. A controller is in communication with the motor while an interface provides an open signal and a close signal to the motor and thereby move the door to the open position and close positions. A processor is in communication with the controller such that the processor is configured to perform a plurality of steps including: providing an open signal to the motor; opening the door via the linear actuator; providing a close signal to the motor; and closing the door via the linear actuator.

Further features and advantages of the invention will appear more clearly on a reading of the following detail description of the preferred embodiment of the invention, which is given by way of non-limiting example only and with reference to the accompanying drawings.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a perspective view of the chicken coop system having the door in an open position, according to an embodiment of the present invention;

FIG. 2 illustrates a perspective view of the chicken coop system having the door in a closed position, according to an embodiment of the present invention;

FIG. 3 illustrates a front elevation view of the controller, according to an embodiment of the present invention;

FIG. 4 illustrates a cutaway view of the linear actuator, according to an embodiment of the present invention;

FIG. 5 illustrates a block diagram of the user control system, according to an embodiment of the present invention; and

FIG. 6 illustrates a block diagram of the system configuration, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the sea chest system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated Discussions and depictions pertaining to these, if present, are presented as examples only and do not limit the applicability of other characteristics, unless otherwise indicated.

In general, the invention described herein relates to a chicken coop having an automated swinging door permitting the ingress and egress of chickens. The chicken coop may take a variety of forms commonly utilized in the arts to effectively protect chickens from predators while roosting. A method of operation of the chicken coop system is also disclosed, providing the user with a manual, or automated system of operation.

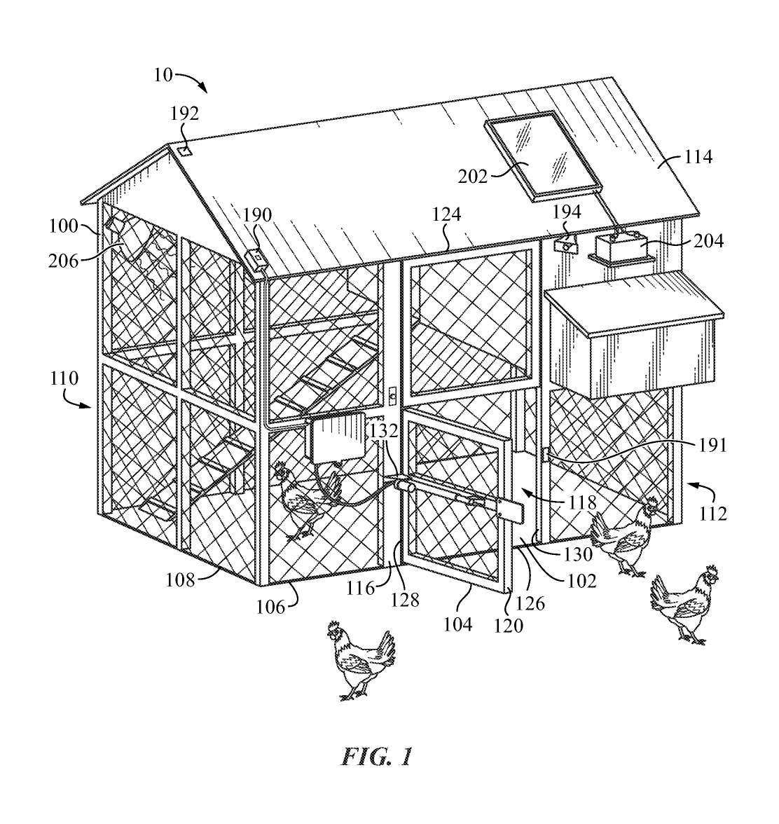

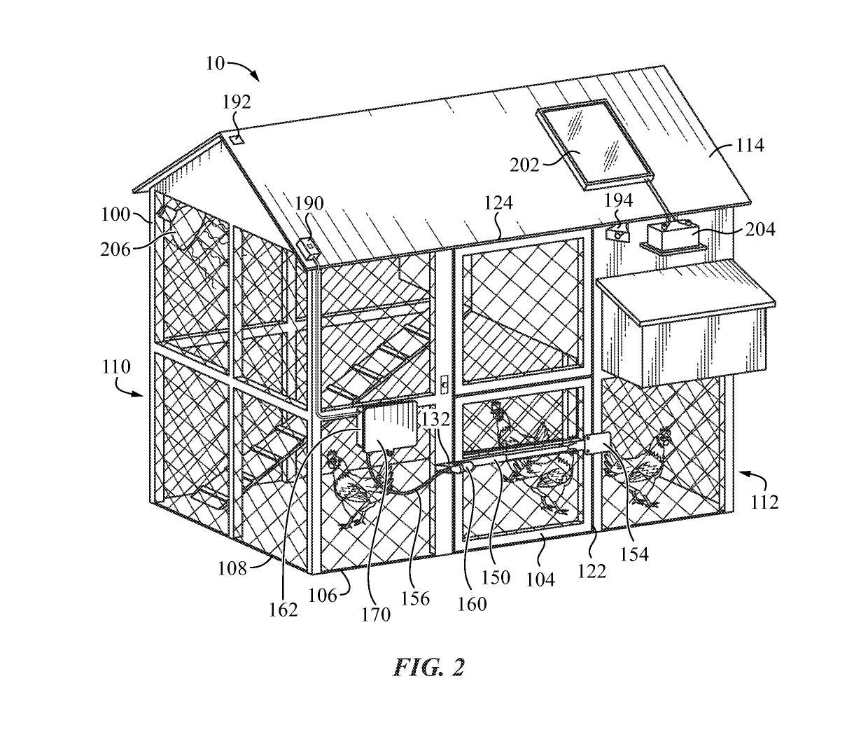

In reference to FIG. 1 and FIG. 2, the chicken coop system 10 includes a housing 100 having a doorway 102 suitably sized for a chicken to ingress and egress therethrough. Suitably sized may be defined as no larger than necessary for at least one chicken to move through in a natural manner. Doorway 102 is automated such that the user is not required to open or secure the doorway throughout the day. The doorway 102 may be comprised of a single, or multiple doors 104 with each door 104 having opening means engageably mounted thereto.

The chicken coop housing 100 is comprised of a plurality of sidewalls 106, 108, 110, 112 and a roof 114 providing a suitable shelter to a plurality of chickens during inclement weather or periods where the risk of encountering a predator is high. Each sidewall may be constructed of a solid material or a fence-like material. The housing may be a standalone structure, or as part of a larger building such as a barn or garage.

Doorway 102 is positioned on sidewall 106 and is suitably sized to permit the ingress and egress of chickens therethrough. Some chicken coop doorways are elevated to help keep the interior of the chicken coop 10 dry. In this embodiment, the chicken coop 10 may have a ramp (not illustrated) to make it easy for chickens to enter and exit the chicken coop 10.

In an embodiment, the chicken coop 10 may be comprised of a frame 116 configured to define a frame opening 118 defining the doorway 102. Frame 116 may be constructed as rectangles by a plurality of frame members since rectangles are simple to construct and may be readily combined to form an overall larger coop 10 if required by the chicken rancher or likewise user. Alternatively, for aesthetic reasons, frame opening 118 may be circular, an oval, or another geometric or irregular shape. Preferentially, the frame is attached to the wall such that the frame opening aligns with the doorway. The frame 116 is suitably constructed to provide support to the roof 114.

FIG. 2 further illustrates the chicken coop 10 having the door 104 in an open position comparative to FIG. 1 wherein the door 104 is shown in a closed position. The door 104 is movably coupled to the frame using a pivot hinge, or similar implement. The pivot hinge is arranged in such a way as to permit the movement of the door 104 between the open and closed positions. In the open position, frame opening 118 and doorway 102 are relatively unobstructed permitting the ingress and egress of chickens freely. Contrarily, in the closed position the door 104 sufficiently blocks doorway and frame opening 118 to restrict the ingress and egress of chickens as well as restrict access from predators.

The door 104 defines a door edge 120. When the door is in a closed position, door edge is recessed within the frame opening 118 rather than being positioned at a resting point of the closed position such that the door edge is on the face of the frame opening 118. This limits the ability of a predator to grip the door edge 120 and force the door 104 open. It is preferred that the door edge 120 be minimally spaced from the inside surface of the frame opening 118 to prohibit predators from accessing the door gap 122 and opening the door 104. Having a minimal door gap 122 may also limit the intrusion of inclement weather.

In an embodiment, the door 104 may seal the frame opening 118 such that wind and moisture do not enter the interior of the chicken coop 10. This may be accomplished by a rubber door seal about the door edge 120 to limit the airflow when the door is in the closed position. The door 104 may be insulated to provide a means for keeping warm air inside the chicken coop when in colder climates.

In an embodiment, the frame opening is a rectangle defined by a top frame portion 124, a bottom frame portion 126, and first and second side frame portions 128, 130. A pivot hinge 132 is configured to permit the door 104 to swing at the hinge 132. The pivot hinge 132 may be positioned on the first side frame portion 128 such that the space between the second side frame portion 130 and the door edge 120 define the door gap 122.

The pivot hinge 132 may include a rod configured to extend vertically between the top frame portion 124 and the collinear bottom frame portion 126 sufficiently near the first side portion 128. The rod defines a longitudinal axis whereabouts the rod pivots to permit the swinging motion of the door 104. While the door 104 is in the closed position, the door face is substantially collinear with the face of the sidewall 106. While the door 104 is in the open position, the door face is substantially perpendicular with the face of sidewall 106. As used herein, the substantially vertical, substantially perpendicular, and substantially parallel are common descriptive terms corresponding to what can be ascertained by simple observation. These terms do not imply any particular degree of accuracy or precision.

In an alternative embodiment, the rod of the pivot hinge 132 may be positioned horizontally along the top or bottom frame members 124, 126 such that the door 104 functions as an awning (when the pivot hinge is positioned along the top frame portion 124) or as a ramp (when the pivot hinge is positioned on the bottom frame portion 126).

One skilled in the arts may appreciate that any number of hinges may be used along the length of the first side frame portion to provide further support, or to allow multiple doors to be utilized in the design at different heights along the first side frame portion.

Now referring to FIG. 4, opening means may be in the form of a linear actuator 150. The linear actuator may be similar to linear actuators known in the arts or other devices providing linear movement of a workpiece. The linear actuator 200 is electrically coupled to a motor unit 300 driving an output shaft 152. The output shaft 152 is movably coupled to the door 104 permitting movement between the open and close positions of the door 104. The output shaft may be comprised of an adapter to pivot, swivel, or hinge as the door 104 moves between open and closed positions.

As is typical in the arts, the linear actuator 150 may be comprised of a rotatable output shaft 152 at a first (or work) end 158 connected to an electric motor. The output shaft of the electric motor is connected through a gear train to a nut and lead screw mechanism. Rotation of the output shaft of the electric motor causes corresponding rotation of the lead screw. The nut has an opening formed therethrough having an internal thread. The lead screw extends the through the opening and has an external thread formed which cooperates with the internal thread formed on the nut. The nut is mounted on the lead screw in such a manner as to be restrained from rotating with the lead screw when the lead screw rotates. In this manner, rotation of the lead screw results in linear movement of the output shaft.

In an embodiment, the output shaft 152 is coupled to member 154 position to suitably extrude from the face of door edge 120. Member 154 contacts the face of frame opening 118 when in the closed position to cease the rotation of the door 104. Suitable extrusion of the member 154 is such that the member 154 extends parallel from the face of the door 104 to contact the second side portion 130 of the frame opening 118. Output shaft 152 is positioned near most the door edge 120. Linear actuator 150 may be secured to the frame 116 at a second end 159 using any means for securing the two known in the arts such as a plate having a plurality of apertures wherein screws may be positioned to fast the linear actuator 150 to the frame 116.

In an embodiment, member 154 include locking means permitting the chicken rancher or other person to manually lock the door if required. This may include an aperture through the member suitable sized to permit a loop to extend therethrough. The loop is positioned on the second side portion 128 of the frame opening 118. When the door 104 is in the closed position, the loop extends through and optionally receives a lock through the loop to stop the linear actuator, predator, or other forced opening of the door 104.

A duct 156 having connection means therethrough electrically connects the linear actuator 150 to the motor unit 160. As known in the arts, the linear actuator may be operated by electrical power, hydraulic power, or pneumatic power requiring duct 156 to house sufficient component for each therein. As a preferred and exemplary embodiment, the linear actuator 150 operates utilizing electrical power, requiring duct 156 to house electrical wiring therein as commonly known.

As illustrated in FIGS. 1 and 2, the motor unit 160 is mounted to the frame 116. It may be beneficial to mount the motor unit 160 on the exterior surface of the chicken coop 10 to prevent unwanted dust and debris from coming in contact with the motor unit 160. Further, the motor unit 160 may be mounted above the travel path of the chickens to prevent the animals from tampering with the motor 160. In an embodiment, the motor unit 160 may be disposed within a protective housing 162 to protect the motor unit components from tampering, debris, and inclement weather.

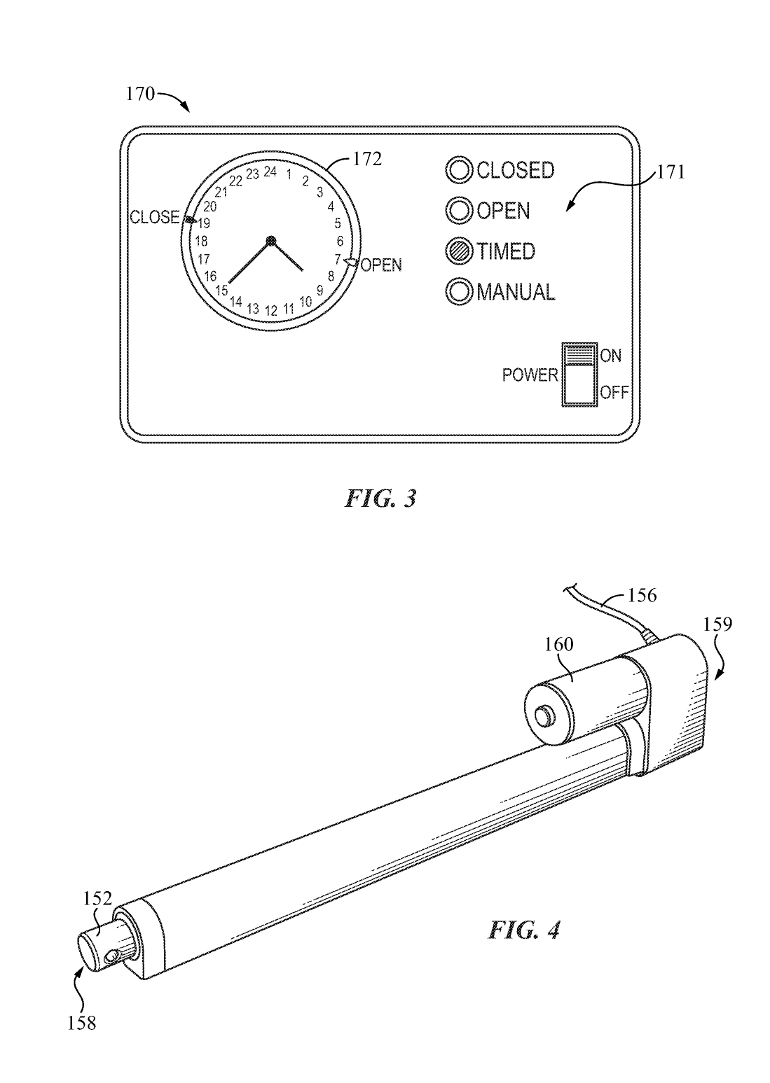

FIG. 3 illustrates a control unit 170 which is in communication with the chicken coop 10 providing an interface for the for various settings and preferences. The control unit 170 may provide a graphical or mechanical user interface 171 having features including but not limited to ON/OFF, OPEN/CLOSE, TIMER, MANUAL, and a clock interface.

The control unit 170 is adapted to output the OPEN and CLOSE signal. The control unit 170 is communicably connected to a motor drive unit 180 such that the control unit 170 may affect the motor drive unit 180 upon the reception of the OPEN or CLOSE signal. When operating in MANUAL mode, the user (chicken rancher) is required to manually select the OPEN or CLOSE options on the interface 172 to send the OPEN or CLOSE signal to the motor drive unit 180.

Naturally, free range chickens will roam throughout the day to feed and return to the coop 10 at or near dusk to roost. To provide an autonomous system and convenience to the user, the coop 10 may include a photo cell 190 mounted to the frame 116. The photocell 190 is communicably connected to the controller via wiring or a networked connection. It may be beneficial to mount the photocell 190 on the roof 114 to provide sufficient sunlight for accurate light interpretations. The photocell 190 must be arranged to be exposed to sunlight so the controller 170 can determine an opening time near sunrise for outputting the OPEN signal, as well as a closing time near sunset for outputting the CLOSE signal. A controller outputting an OPEN and CLOSE signal only in response to a signal from the photocell 190 may only need simple logic type electronics to effectively control the position of the door 104.

In another embodiment, the coop 10 includes a timer 172 coupled to the controller 170 and configured to output a timer signal for determining an opening time to output the OPEN signal and closing time to output the CLOSE signal. The timer may be in communication with a microprocessor and memory so that the opening time and closing time can be programmed into the controller 170.

It may be desirable for the coop system 10 to have both a timer 172 and a photocell 190 with each in communication with the controller. In this manner, output of OPEN and CLOSE signals may be dependent on any combination of the timer signal and the photo cell signal. While the photocell 190 provides way for the coop 10 to modulate the timing of the signal dependent on the time of year, the timer 172 may provide a failsafe if clouds or other sunlight obstructions prohibit an accurate reading of daylight. This permits the coop 10 to operate autonomously even with changing daylight times throughout the seasons.

In an embodiment, a climate sensor 192 may be in communication with controller 170. They climate sensor 192 may modify the timing of the OPEN and CLOSE signals if there are unfavorable weather conditions which may be unhealthy for the chickens.

Further, the coop system 10 may have a door closed switch 191 and an alarm 194 in communication with the controller 170. The door closed contact switch 191 is arranged to be activated when the door 104 is in the closed position. Upon inadequate contact of the door 104 and the contact switch 191 during a CLOSE period, the controller may activate the alarm. The alarm may take the form of any attention getting device including visual and audio cues within the coop 10 or at a remote location such as at the user's home. The trigger of the alarm 194 may result in a secondary CLOSE signal to affect the linear actuator to close the door 104.

In an embodiment, the user may manually close or open the door. The manual input of the close or open signal will not disrupt the following open or close signal. In an example, the user may manually close the door during the day. This manual input to close the door will not disrupt the open signal the following morning upon sunrise or other input.

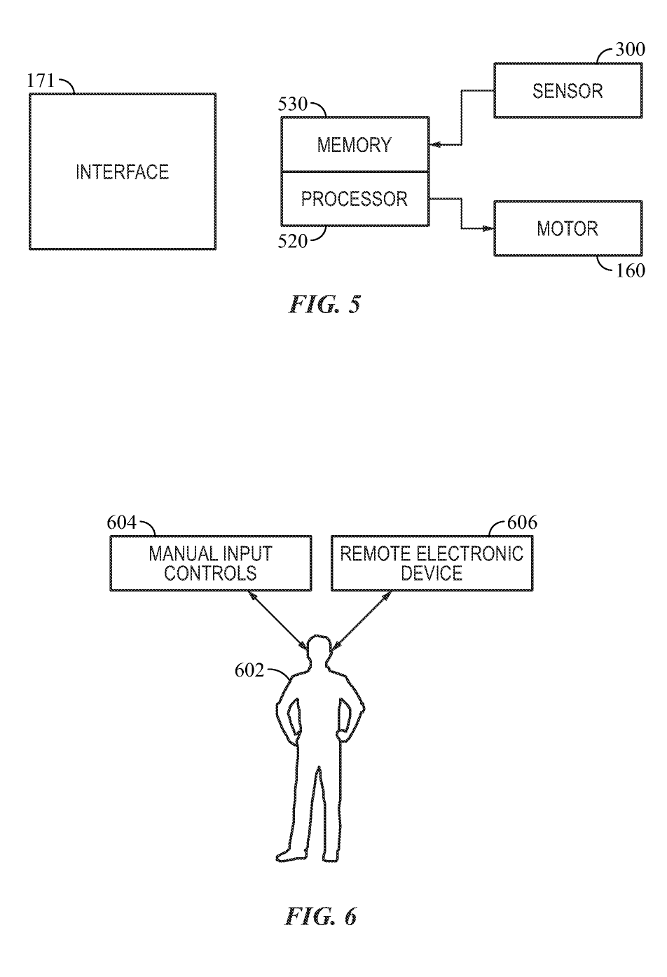

FIG. 5 illustrates a block diagram showing how the automated chicken coop 10 may be controlled by the user. While the coop system 10 is capable of full manual operation, the user control system 500 permits for additional customization, user control, and feedback of the automated features described herein. Interface 171 may include a touchscreen interface or mechanical solid state means to allow the user to input commands and display relevant information to the user. The interface 171 is connected to a processor 520 that includes a memory 530 for storing relevant information related to the operation of the chicken coop system 10. This may include historical sunrise and sunset times from previous years, as well as times gleaned from external sources of information such as weather applications. The processor 520 receives input information from each sensor including the photocell 190, timer 172, alarm 194, and climate sensor 192 among other sensors that may be utilized in tandem with the system 10. The processor may also receive information related to the position of the door 104 via the contact sensor or linear actuator components. The processor is also in communication with the motor 160 to control operation of the door 104.

Any suitable sensor may be utilized including but not limited to electromagnetic sensors, photoelectric sensors, motion sensors, or active infrared activity sensors.

In an embodiment, the user may set a predetermined delay before or after a sunrise or sunset event. The delay may serve to protect the chickens from unhealthy conditions including periods of inclement weather or the temporary presence of a predator.

The system 10 may be provided along with an energy storage device 204 and energy collection device 202. The energy collection device may include any number of solar panels to collect sunlight and emit electrical power via a transformer. The energy storage device 204, may be any battery commonly used in the arts to store and transmit power to the system.

In a further embodiment, the system 10 may be provided with an automatic feeder 208 configured to dispense feed upon the reception of an open signal from the controller Upon the reception of a close signal, the feeder 208 may stop dispensing feed. The system may also provide a heat lamp 206 that may turn on upon the reception of the close signal. The heat lamp 206 may also receive a signal to turn on provided by the climate sensor 192, or timer 172.

FIG. 6 illustrates a system configuration in an embodiment of the present invention. User 602 is in communication with each of a manual input control 604 as well as remote electronic device 606. Manual input controls may include any controls on interface 171 as well as a doorbell push button provided on the coop 10. The remote electronic device 606 may include a PED, computer, or other electronic system allowing the user to communicate with the manual input controls 604.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An automated chicken coop comprising:
a housing having a framed opening, wherein the framed opening is defined by a top frame portion, a bottom frame portion, a first side portion, and a second side portion;
at least one pivot hinge movably coupled to the first side portion;
a door movably coupled to the housing by the at least one pivot hinge, the door having an edge dimensioned to selectively obstruct the frame opening, wherein the door is movable between an open position wherein the door is substantially vertical and substantially perpendicular to the housing, and a close position wherein the door is substantially vertical and substantially parallel to the housing;
a linear actuator having a fixed end and a work end, wherein the fixed end is coupled to the at least one pivot hinge, wherein the work end is engaged with the door edge wherein the linear actuator is in communication with a motor, wherein the motor is configured to affect the linear actuator to forcefully rotate the door about a rotational axis provided by the pivot hinge between the open position and the close position;
a controller in communication with the motor, the controller having an interface, wherein the interface provides an open signal and a close signal to the motor and thereby move the door to the open position and the close position.

2. The chicken coop of claim 1 further comprising a photocell in communication with the controller, wherein the photocell is arranged to be exposed to sunlight to determine an open time sufficiently near sunrise for outputting the open signal and a close time sufficiently near sunset for outputting the close signal.

3. The chicken coop of claim 1, further comprising a timer in communication with the controller, wherein the timer is configured to output a timer signal to determine the open time for outputting the open signal and the close time for outputting the close signal.

4. The chicken coop of claim 3, further comprising a memory and a processor, wherein the memory stores open and close times.

5. The chicken coop of claim 1 further comprising a climate sensor in communication with the controller, wherein the climate sensor is configured to output the open signal and the close signal dependent on climate conditions.

6. The system of claim 1, wherein the control is comprised of a manual input for the open signal, wherein the manual input for the open signal does not disrupt the close signal, wherein the control is comprised of a second manual input for the close signal, wherein the manual input for the close signal does not disrupt the open signal.

7. The chicken coop of claim 6 further comprising:
a door close switch arranged to be activated when the door is in the closed position; and
an alarm in communication with the door closed switch, wherein the alarm is configured to provide an indication of when the alarm is activated, and wherein the alarm is in communication with the controller.

8. The system of claim 7, wherein the controller alerts a remote user when the alarm is activated.

9. The system of claim 8, wherein the alarm is distributed in a plurality of remote locations.

10. A chicken coop system comprising:
a housing having an opening, wherein the opening is defined by a top frame portion, a bottom frame portion, a first side portion, and a second side portion;
at least one pivot hinge movably coupled to the first side portion;
a door movably coupled to the frame by the at least one pivot hinge, wherein the door is movable between an open position wherein the door is substantially vertical and substantially perpendicular to the housing, and a close position wherein the door is substantially vertical and substantially parallel to the housing such that the opening is sufficiently obstructed by the door;
a linear actuator having a fixed end and a work end, wherein the fixed end is coupled to the at least one pivot hinge, wherein the work end is engaged with the door edge wherein the linear actuator is in communication with a motor, wherein the motor is configured to affect the linear actuator to forcefully rotate the door about a rotational axis provided by the pivot hinge between the open position and the close position;
a controller in communication with the motor, the controller having an interface, wherein the interface provides an open signal and a close signal to the motor and thereby move the door to the open position and the close position; and
a processor in communication with the controller, wherein the processor is configured to perform the following steps of:
providing an open signal to the motor;
opening the door via the linear actuator;
providing a close signal to the motor; and
closing the door via the linear actuator.

11. The system of claim 10, wherein the controller is in communication with at least one user.

12. The chicken coop of claim 10 further comprising a photocell in communication with the controller, wherein the photocell is arranged to be exposed to sunlight to determine an open time sufficiently near sunrise for outputting the open signal and a close time sufficiently near sunset for outputting the close signal.

13. The chicken coop of claim 10, further comprising a timer in communication with the controller, wherein the timer is configured to output a timer signal to determine the open time for outputting the open signal and the close time for outputting the close signal.

14. The chicken coop of claim 13, further comprising a memory, wherein the memory stores open and close times.

15. The chicken coop of claim 10 further comprising a climate sensor in communication with the controller, wherein the climate sensor is configured to output the open signal and the close signal dependent on climate conditions.

16. The chicken coop of claim 10 further comprising:
a door close switch arranged to be activated when the door is in the closed position; and
an alarm in communication with the door closed switch, wherein the alarm is configured to provide an indication of when the alarm is activated, and wherein the alarm is in communication with the controller.

17. The system of claim 16, wherein the controller alerts a remote user when the alarm is activated.

18. The system of claim 17, wherein the controller setting can be modified via a remote electronic device.

19. The system of claim 10, further comprising a heat lamp, wherein the heat lamp receives a heat signal from the controller in addition to the close signal, wherein the heat lamp turns on following the close signal, wherein the open signal discontinues the heat signal.

20. The system of claim 10, further comprising a feeder, wherein the feeder receives a feed signal from the controller in addition to the open signal, wherein the feeder turns on following the open signal, wherein the close signal discontinues the feed signal.
